(19) United States
(12) Patent Application Publication
(10) Pub. No.: US 2026/0054355 A1
(43) Pub. Date: Feb. 26, 2026

(54) SLEEVE

(71) Applicant: KABO TOOL COMPANY, Taichung City (TW)

(72) Inventor: Chih-Ching HSIEH, Taichung City (TW)

(21) Appl. No.: 19/307,003

(22) Filed: Aug. 21, 2025

(30) Foreign Application Priority Data
Aug. 23, 2024 (TW) 113131695

(51) Int. Cl. B25B 13/46

(52) U.S. Cl. CPC B25B 13/461

(57) ABSTRACT

A sleeve includes a plugging structure, a stopping structure and a driven structure. The plugging structure includes a plugging body, a plugging hole and at least one inclined tapering groove. An end of the plugging body has a plugging hole periphery. The plugging hole is extended through the plugging body. The at least one inclined tapering groove is disposed to the plugging body. The stopping structure is disposed to the other end of the plugging body. The driven structure is disposed to an end of the stopping structure. The at least one inclined tapering groove is extended from the plugging hole periphery to the stopping structure. The plugging hole is a square hole, and the plugging body has four corners, each of the four corners has a plugging groove, the plugging groove is extended from the plugging hole periphery to the stopping structure.

### RELATED APPLICATIONS

This application claims priority to Taiwan Application Serial Number 113131695, filed Aug. 23, 2024, which is herein incorporated by reference.

### BACKGROUND

### Technical Field

The present disclosure relates to a hand tool. More particularly, the present disclosure relates to a sleeve.

### Description of Related Art

With the development of industry, mechanical structures have become more complex, which lead to the prevalence of hand tools. Sleeves and sleeve driven elements are more popular, because of easily locking or removing the fastener in narrow spaces.

However, the plugging hole of the conventional sleeve does not have a complete guiding structure, so that, during operation, the user needs to align the plugging portion of the sleeve driven element and the plugging hole of the sleeve before connecting the sleeve driven element and the sleeve, thereby causing inconvenience in use.

In view of this, how to connect the socket drive element and the socket more quickly has become the goal that related industries strive for.

### SUMMARY

According to one aspect of the present disclosure, a sleeve includes a plugging structure, a stopping structure and a driven structure. The plugging structure includes a plugging body, a plugging hole and at least one inclined tapering groove. An end of the plugging body has a plugging hole periphery. The plugging hole is extended through the plugging body. The at least one inclined tapering groove is disposed to the plugging body. The stopping structure is disposed to the other end of the plugging body. The driven structure is disposed to an end of the stopping structure. The at least one inclined tapering groove is extended from the plugging hole periphery to the stopping structure. The plugging hole is a square hole, and the plugging body has four corners, each of the four corners has a plugging groove, the plugging groove is extended from the plugging hole periphery to the stopping structure.

### BRIEF DESCRIPTION OF THE DRAWINGS

The present disclosure can be more fully understood by reading the following detailed description of the embodiment, with reference made to the accompanying drawings as follows:

FIG. 1 is a three dimensional schematic view of a sleeve according to an embodiment of the present disclosure.

FIG. 2 is a cross-sectional schematic view of the sleeve according to FIG. 1.

FIG. 3 is a top schematic view of the sleeve according to FIG. 1.

FIG. 4 is a cross-sectional schematic view of the sleeve along a line 4-4 according to FIG. 2.

### DETAILED DESCRIPTION

The embodiment of the present disclosure will be described below with reference to the accompanying drawings. The following description will include many practical details in order to be clear and specific. The reader, however, should understand that those practical details are not intended to be restrictive of the scope of the invention; in other words, the practical details are not essential to some embodiments of the invention. Besides, for the sake of simplicity of the drawings, some conventional or commonly used structures and elements are drawn only schematically in the drawings, and repeated elements may be indicated by the same reference numeral or similar reference numerals.

In addition, when a certain element (or unit, module, etc.) is “connected” to another element herein, it may mean that the element is directly connected to another element, or it may also mean that a certain element is indirectly connected to another element, that is, there are other elements interposed between the element and another element. When it is expressly stated that an element is “directly connected” to another element, it means that no other element is interposed between the element and the other element. The terms first, second, third, etc. are only used to describe different elements, and do not limit the elements themselves. Therefore, the first element can also be renamed as the second element. The combination of elements/units/circuits herein is not commonly known, conventional or well-known in the field, and it cannot be determined whether the combination relationship can be easily completed by those with ordinary knowledge in the technical field based on whether the elements/units/circuits themselves are well-known.

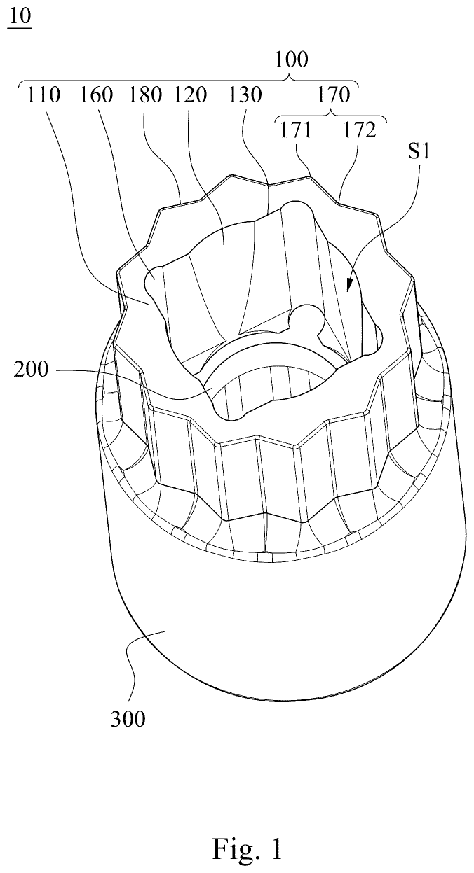

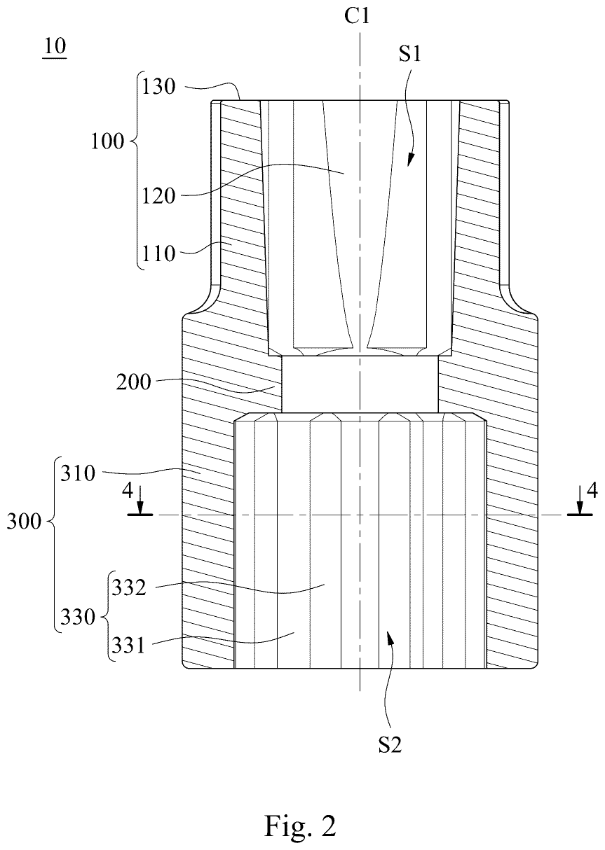

Please refer to FIG. 1 and FIG. 2. FIG. 1 is a three dimensional schematic view of a sleeve 10 according to an embodiment of the present disclosure. FIG. 2 is a cross-sectional schematic view of the sleeve 10 according to FIG. 1. The sleeve 10 includes a plugging structure 100, a stopping structure 200 and a driven structure 300. The plugging structure 100 includes a plugging body 110, a plugging hole S1 and at least one inclined tapering groove 120. An end of the plugging body 110 has a plugging hole periphery 130. The plugging hole S1 is extended through the plugging body 110. The at least one inclined tapering groove 120 is disposed to the plugging body 110. The stopping structure 200 is disposed to the other end of the plugging body 110. The driven structure 300 is disposed to the end of the stopping structure 200. The at least one inclined tapering groove 120 is extended from the plugging hole periphery 130 to the stopping structure 200, so that a sleeve driven element (not shown) can be slid along the at least one inclined tapering groove 120 and be inserted into the plugging hole S1.

Therefore, the inclined tapering groove 120 is disposed to the plugging body 110, so that the sleeve driven element can be more quickly inserted into the plugging hole S1 for increasing the convenience of usage.

The driven structure 300 can include a driven body 310 and a driven hole S2. The driven hole S2 is extended through the driven body 310. Each of the plugging structure 100 and the driven structure 200 is substantially tubular shape. The stopping structure 200 is a hollow ring. In detail, the plugging hole S1 disposed to the plugging structure 100 can be communicated to the driven hole S2 disposed to the driven structure 300 by a center space (its reference numeral is omitted) of the stopping structure 200. It should be noted that the inner diameter of the stopping structure 200 is smaller than a minimal hole diameter (its reference numeral is omitted) of the plugging hole S1 and smaller than a minimal hole diameter (its reference numeral is omitted) of the driven hole S2. The sleeve driven element can be a sleeve wrench, which includes a plugging portion, and the shape of the plugging portion is corresponding to the plugging hole S1, substantially. The plugging potion can be inserted into the plugging hole S1. The driven structure 300 can be corresponding to a fastener (not shown), so that the fastener can be locked or disassembled by the driven structure 300.

As shown in FIG. 1, the plugging hole S1 can be is a square hole, and the plugging body 110 has four corners. Each of the four corners has a plugging groove 160, and the plugging groove 160 is extended from the plugging hole periphery 130 to the stopping structure 200. Specifically, the plugging hole S1 is a square through hole. The plugging hole periphery 130 is located at the end (which is away from the driven structure 300) of the plugging body 110. Each plugging groove 160 is an arc-shaped, and each plugging groove 160 is extended perpendicularly from the plugging hole periphery 130 to the stopping structure 200. The plugging groove 160 is disposed at each corner of the plugging body 110, which can provide appropriate space for the four corners of the plugging portion of the sleeve driven element to enter or exit, so that the plugging portion can be smoothly inserted into the plugging hole S1.

The at least one inclined tapering groove 120 may have a curved surface, which is gradually shrunk from the plugging hole periphery 130 to the stopping structure 200. In the embodiment of FIG. 1 and FIG. 2, a number of the at least one inclined tapering groove 120 is four. The four inclined tapering grooves 120 are disposed to the four inner walls of the plugging body 110, respectively. Each of the inclined tapering grooves 120 is extended along the direction from plugging hole periphery 130 toward the stopping structure 200 and is gradually shrunk from the plugging hole periphery 130 to the stopping structure 200, and at the same time gradually and inwardly shrunk along the radial direction toward the sleeve 10. The plugging structure 100 can further include an outer teeth portion 170. By the arrangement of the inclined tapering grooves 120, the plugging body 110 without chamfers can remain the width between the plugging hole periphery 130 and an outer teeth periphery 180 of the outer teeth portion 170, thereby improving the structure strength. In other embodiments, the number of the inclined tapering grooves may not be four, and the present disclosure is not limited thereto.

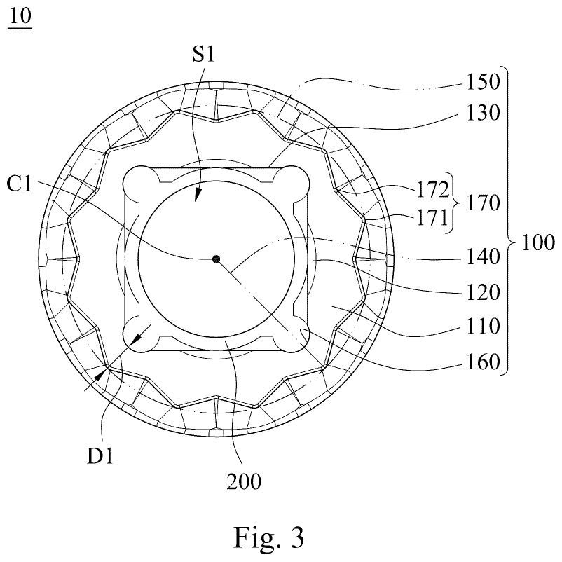

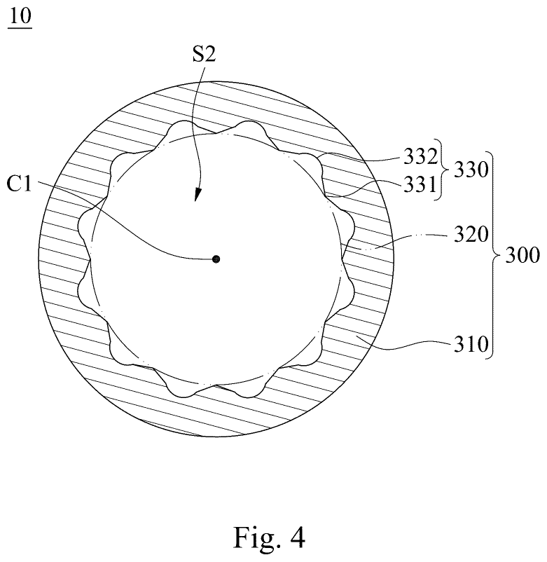

Please refer to FIG. 3 and FIG. 4. FIG. 3 is a top schematic view of the sleeve 10 according to FIG. 1. FIG. 4 is a cross-sectional schematic view of the sleeve 10 along a line 4-4 according to FIG. 2. In FIG. 1 to FIG. 4, the outer teeth portion 170 of the plugging structure 100 is located at an outer wall of the plugging body 110. The outer teeth portion 170 can include a plurality of outer teeth protruded portions 171 and a plurality of outer teeth recessed portions 172. Each of the outer teeth recessed portions 172 is located between each two of the outer teeth protruded portions 171 which are adjacent to each other. The plugging structure 100 can define a plugging circumcircle 150, the plugging circumcircle 150 connects a vertex of each of the outer teeth protruded portions 171, a diameter of the plugging circumcircle 150 is smaller than an outer diameter of the driven structure 300. The plugging circumcircle 150 is a virtual circle centered at center point of the plugging hole S1.

Specifically, the outer teeth portion 170 can be disposed around the outer wall of the plugging body 110, which is formed integrally. Each of the outer teeth protruded portions 171 of the outer teeth portion 170 can be protruded outwardly along a radial direction of the sleeve 10. Each of the outer teeth recessed portions 172 of the outer teeth portion 170 can be recessed inwardly along the radial direction of the sleeve 10. The outer teeth protruded portions 171 and the outer teeth recessed portions 172 are extended perpendicularly from an end (which is away from the driven body 310) of the plugging body 110 toward the driven body 310. Each of the outer teeth recessed portions 172 is located between each two of the outer teeth protruded portions 171 which are adjacent to each other. Each of the outer teeth protruded portions 171 is located between each two of the outer teeth recessed portions 172 which are adjacent to each other. Thus, the number of the outer teeth protruded portions 171 is equal to the number of the outer teeth recessed portions 172. In this embodiment of FIG. 3 and FIG. 4, the number of the outer teeth protruded portions 171 and the number of the outer teeth recessed portions 172 are twelve. By connecting the vertex of each of the outer teeth protruded portions 171, can form the plugging circumcircle 150. The diameter of the plugging circumcircle 150 is smaller than the outer diameter of the driven structure 300. In other embodiments, the number of the outer teeth protruded portions and the number of the outer teeth recessed portions can be greater or smaller than twelve, and the diameter of the plugging circumcircle can be equal to the outer diameter of the driven structure or greater than the outer diameter of the driven structure, but the present disclosure is not limited thereto. It should be noted that the outer teeth portion 170 is disposed around the outer wall of the plugging structure 100, so that the user can directly hold the outer teeth portion 170 with hand, and then pivot the sleeve 10 by a frictional force between the outer teeth portion 170 and the hand. Besides, the sleeve driven element can be connected to the outer teeth portion 170 to improve the torque, thereby more easily pivoting the sleeve 10.

As shown in FIG. 3, the plugging structure 100 of the sleeve 10 may have at least one corner width D1, which is located from at least one of the four corners of the plugging body 110 to a periphery of the plugging body 110 and is extended through a center point of the plugging hole periphery 130. The at least one corner width D1 is a minimum of widths of the plugging body 110. In detail of this embodiment, the periphery of the plugging body 110 can be the outer teeth periphery 180 of outer teeth portion 170. A center point of the plugging hole periphery 130 can be extended toward each corner of the plugging hole periphery 130, so as to define a virtual extension line 140. The virtual extension line 140 can be corresponding to a point of the plugging hole periphery 130 and a point of the outer teeth periphery 180. The corner width D1 is not only a distance between the point of the plugging hole periphery 130 and the point of the outer teeth periphery 180 but also the minimum width of the entire plugging body 110.

Specifically, four virtual extension lines 140 can be formed from the center point of the plugging hole periphery 130 extending toward four corners of four plugging grooves 160, respectively. Each virtual extension line 140 can extend sequentially through the plugging hole periphery 130 and the outer teeth periphery 180. The distance between the two intersection points (the each virtual extension line 140 intersects the plugging hole periphery 130 and the outer teeth periphery 180) is the corner width D1. In the embodiment of FIG. 3, the corner width D1 can be smaller than 4 mm. In other embodiments, the corner width D1 can be equal to 4 mm or greater than 4 mm. However, the present disclosure is not limited thereto.

Please refer to FIG. 4. The driven structure 300 can include a driven body 310 and an inner teeth portion 330. The inner teeth portion 330 is disposed to an inner wall of the driven body 310, and the inner teeth portion 330 can include a plurality of inner teeth protruded portions 331 and a plurality of inner teeth recessed portions 332. Each of the inner teeth recessed portions 332 is located between each two of the inner teeth protruded portions 331 which are adjacent to each other. The driven structure 300 can define a driven inscribed circle 320. The driven inscribed circle 320 connects a vertex of each of the inner teeth protruded portions 331. A diameter of the driven inscribed circle 320 is greater than an inner diameter of the stopping structure 200. The driven inscribed circle 320 is a virtual circle centered at the center point of the driven hole S2. It should be noted that the center point of the plugging hole S1, the center point of the driven hole S2 and the center point of the plugging hole periphery 130 are collinear and located on a central axis C1. The central axis C1 is a virtual axis and is parallel to the length extension direction of the sleeve 10.

Specifically, the inner teeth portion 330 can be disposed around the outer wall of the driven body 310, which is formed integrally Each of the inner teeth protruded portions 331 of the inner teeth portion 330 can be protruded inwardly along a radial direction of the sleeve 10. Each of the inner teeth recessed portions 332 of the inner teeth portion 330 can be recessed outwardly along the radial direction of the sleeve 10. The inner teeth protruded portions 331 and the inner teeth recessed portions 332 are extended perpendicularly from an end (which is away from the plugging body 110) of the driven body 310 toward the plugging body 110. Each of the inner teeth recessed portions 332 is located between each two of the inner teeth protruded portions 331 which are adjacent to each other. Each of the inner teeth protruded portions 331 is located between each two of the inner teeth recessed portions 332 which are adjacent to each other. Thus, the number of the inner teeth protruded portions 331 is equal to the number of the inner teeth recessed portions 332. In the embodiment of FIG. 4, the number of the inner teeth protruded portions 331 and the number of the inner teeth recessed portions 332 are twelve. By connecting the vertex of each of the inner teeth protruded portions 331, can form the driven inscribed circle 320. A diameter of the driven inscribed circle 320 is greater than an inner diameter of the stopping structure 200. When the user locks or disassembles the fastener, the fastener can be engaged with the inner teeth portion 330 and be limited by the stopping structure 200, so that the fastener can be limited in the driven hole S2. In other embodiments, the number of the inner teeth protruded portions and the number of the inner teeth recessed portions can greater or smaller than twelve. However, the present disclosure is not limited thereto.

The plugging structure 100, the stopping structure 200 and driven structure 300 can be formed integrally. In this embodiment of FIG. 1 to FIG. 4, all structures (all elements) of the sleeve 10 are formed integrally. The plugging hole S1, the inclined tapering grooves 120, the plugging groove 160, the plugging hole S2, the outer teeth portion 170 and the inner teeth portion 330 can be correspondingly arranged on the mold of the sleeve 10. Therefore, the sleeve 10 can be forged in one step, thereby saving production time and production costs.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A sleeve, comprising:
a plugging structure comprising:
a plugging body, wherein an end of the plugging body has a plugging hole periphery;
a plugging hole extended through the plugging body; and
at least one inclined tapering groove disposed to the plugging body;
a stopping structure disposed to the other end of the plugging body;
a driven structure disposed to an end of the stopping structure;
wherein the at least one inclined tapering groove is extended from the plugging hole periphery to the stopping structure;
wherein the plugging hole is a square hole, and the plugging body has four corners, each of the four corners has a plugging groove, the plugging groove is extended from the plugging hole periphery to the stopping structure.

2. The sleeve of claim 1, wherein the at least one inclined tapering groove has a curved surface.

3. The sleeve of claim 1, wherein the at least one inclined tapering groove gradually are shrunk from the plugging hole periphery to the stopping structure.

4. The sleeve of claim 1, wherein the plugging structure, the stopping structure and the driven structure are formed integrally.

5. The sleeve of claim 1, wherein the plugging structure has at least one corner width, which is located from at least one of the four corners of the plugging body to a periphery of the plugging body and is extended through a center point of the plugging hole periphery, and the at least one corner width is a minimum of widths of the plugging body.

6. The sleeve of claim 1, wherein the plugging structure further comprises an outer teeth portion, the outer teeth portion is located at an outer wall of the plugging body, the outer teeth portion comprises:
a plurality of outer teeth protruded portions; and
a plurality of outer teeth recessed portions, wherein each of the outer teeth recessed portions are located between each two of the outer teeth protruded portions which are adjacent to each other;
wherein the plugging structure defines a plugging circumcircle, the plugging circumcircle connects a vertex of each of the outer teeth protruded portions, a diameter of the plugging circumcircle is smaller than an outer diameter of the driven structure.

7. The sleeve of claim 1, wherein the driven structure comprises a driven body and an inner teeth portion, the inner teeth portion is disposed at an inner wall of the driven body, the inner teeth portion comprises:
a plurality of inner teeth protruded portions; and
a plurality of inner teeth recessed portions, wherein each of the inner teeth recessed portions is located between each two of the inner teeth protruded portions which are adjacent to each other;
wherein the driven structure defines a driven inscribed circle, the driven inscribed circle connects a vertex of each of the inner teeth protruded portions, a diameter of the driven inscribed circle is greater than an inner diameter of the stopping structure.
